(19) United States
(12) Patent Application Publication
(10) Pub. No.: US 2023/0174427 A1
(43) Pub. Date: Jun. 8, 2023

(54) FOAMED HAIR-REINFORCED CLAY (FHRC) WITH LESS DENSITY AND MORE RESISTANCE THAN ORDINARY CLAY

(71) Applicant: Mona ZARYOUN, Tehran (IR)

(72) Inventors: Mona ZARYOUN, Tehran (IR); Mahmood HOSSEINI, Tehran (IR)

(21) Appl. No.: 18/010,822

(22) PCT Filed: Aug. 19, 2020
(86) PCT No.: PCT/IB2020/055774

§ 371 Date: Dec. 16, 2022

(51) Int. Cl. C04B 28/00; C04B 18/18; C04B 38/10

(52) U.S. Cl. CPC C04B 28/001; C04B 18/18; C04B 38/10; C04B 2111/40

(57) ABSTRACT

The main weaknesses of masonry buildings, especially those made of clay, against earthquakes are: high weight, which increases the earthquake force that is proportional to the weight; low resistance that causes an early crushing of walls and ceilings; lack of ductility, which causes the masonry buildings to collapse immediately after cracking. These weaknesses have been the main causes of collapse of masonry buildings in past earthquakes in various parts of the world. Also, many of the restoration works, done on the historical monuments that were made by the mentioned materials, showed their inadequacy in some recent earthquakes This invention improves clay, as an eco-friendly, low-cost material with high workability, to present a better seismic behavior, by decreasing its specific weight to less than tones/m³ and increasing its tensile resistance up to five times of the ordinary clay, and giving better insulation capabilities against heat, sound and moisture to it.

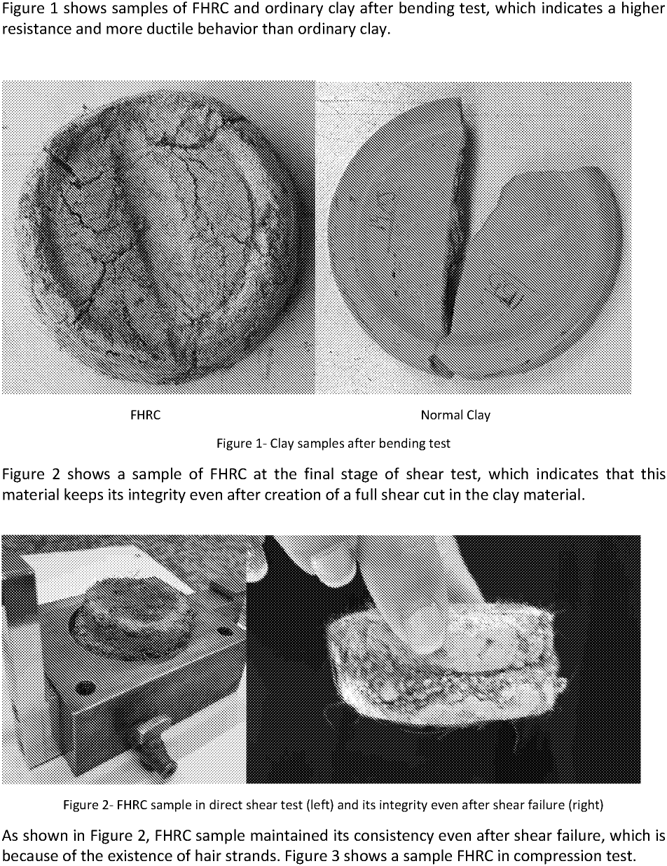

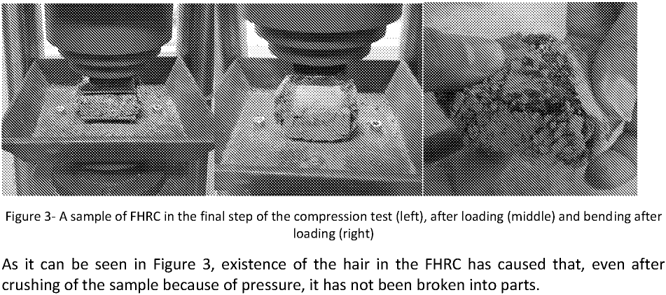

### FIELD OF THE INVENTION AND ITS BACKGROUND

This invention is in the field of building materials for sustainable architecture and disaster resilient structures, especially against earthquakes. Clay is a cheap, eco-friendly material, but the high density and low strength of clay in its original condition have caused the buildings made of this material to collapse in several past earthquakes. However, if it can be made lighter and at the same time stronger, the buildings made of this improved material would receive less seismic forces, and would have more resistance and stability against earthquakes. Furthermore, the lightness of materials would lead to reduction in transportation and construction costs.

The main weaknesses of masonry buildings against earthquake, especially adobe and clay include:
High weight, which increases the earthquake induced forces
Low resistance, particularly in tension, which leads to heavy damages to the body of walls and ceilings of the buildings in large and even moderate earthquakes
Lack of ductility of masonry materials, which causes buildings to collapse quickly after cracking

The purpose of this invention is to improve the specifications of clay, as an eco-friendly, low-cost material with high workability, to present a better seismic behavior, by reducing its specific weight and increasing its resistance, particularly in tension, as well as its ductility, so that it can keep its integrity after cracking.

In an article entitled “An Innovative Technique of Improving the Soil Using Human Hair Fibers”, by Pillai and Ramanathan, in Proceedings of the 3rd International Conference on Construction in Developing Countries in 2012, it has been mentioned that by adding two percent of human hair to clay, its compressive strength is approximately doubled [1]. In another article entitled “An Innovative Method of Improving Subgrade Strength of Soft Soil Using Human Hair Fibers as Reinforcement”, by Patil and Harini, in International Journal of Scientific Research in Science, Engineering and Technology in 2016, it is stated that by adding 0.1% hair to the soil, its compressive strength increases by more than 70% [2]. Also, in another article entitled “Stabilization of Clay with Human Hair Fiber”, by Narayanan and Rebekah, in International Journal of Civil Engineering and Technology (IJCIET) in 2017, referring to human hair as a natural waste material, it has been stated that hair is non-biodegradable and that the compressive strength of clay by adding 1.2% human hair increase from 125 to 209 kg force per square centimeter [3].

### INNOVATION OF THE INVENTION

The innovation of this invention is high mechanical strength and low specific weight of FHRC material, and the ability to maintain its integrity even after cracking.

### HOW TO MAKE THE FHRC MATERIAL

FHRC is made of the combination of 73% clay passed through the sieve No. 25, 24% water, 1.5% foam, and 0.5% natural hair fiber pieces approximately 1.5 to 2 cm long. The steps of making FHRC material are as follow:
Mixing water and foam liquid, and stirring the mixture till reaching the maximum volume of the foam
Adding clay and hair strands pieces, and stirring the mixture again till having a uniform composition
Pouring the uniform mixture into the mold, and storing it at room temperature for a week (or shorter time in higher temperature) to dry completely.

### ADVANTAGES OF FHRC MATERIAL OVER ITS SIMILAR ONES

By this invention, for the first time the combined usage of lightening admixture and reinforcing fibers is addressed, resulting in a fully indigenous and economical material that is easily usable, and its specific weight is 1.5 times less than the normal clay (the specific weight of clay in normal compacted conditions is close to 2). The foam material used in FHRC can be natural- or artificial-based materials. FHRC is stronger than ordinary clay in shear, bending and compression, respectively, 4, 6 and 1.5 times on average.

FHRC has also more insulation capability against heat, sound and moisture than ordinary clay, thanks to its high porosity and also high resistance of clay to heat. In the event of a fire, FHRC can keep healthy the strands of hair inside the material. High heat capacity also helps to store energy in the building that is an important feature of sustainable architecture. Finally, FHRC is more resistant to moisture than traditional clay, and can be used in various parts of the building including:
Partition
False Ceiling
Hollow outer walls and their interior
Flooring materials under finished cover
Load bearing walls in masonry buildings

FHRC can be used in all types of conventional buildings as the main material for the construction of exterior and interior walls, false ceiling tiles, flooring and even load bearing walls in traditional masonry buildings, preventing the buildings from collapse, even after cracking, which as a result, save human lives. Using this material would also extend the useful lifespan of the building as well as that of walls and ceilings of the buildings retrofitted by this material.

It is also worth mentioning that since the integrity of the whole building cannot be kept, if parts of it are made of traditional blocks or bricks, even if the used mortar is strong enough. This is while the materials of this invention can be used to build different parts of buildings without the need for mortar even for rural homes. On this basis, FHRC can be used for the construction of new buildings as well as the restoration of the monuments.

High performance and moldability can be considered as another advantage of FHRC material. This merit makes it easy to work with the material in the factory for manufacturing, and also at the construction sites. FHRC material is also suitable for prefabricated building elements, which their use increases the speed of construction. FHRC can also be used for creation of different types of building components, even decorative elements, in different shapes and sizes.

Finally, a little moisture inside the building can make the FHRC create a good scent, which is usually felt after rain in dry areas, and give the building users a great feeling. Due to the color of the materials of this invention, if dark appearance is not desired, it can be easily painted and coated with a thin layer of material such as plaster.

### ILLUSTRATIONS

Some useful pictures are provided in a separate file, which help to better understand the specifications and features of the FHRC material.

### REFERENCES

Pillai, R.R. and Ramanathan, A., 2012, July. An innovative technique of improving the soil using human hair fibers. In Proceedings of the 3rd international conference on construction in developing countries (pp. 4-6).

Patil, P. and Harini, H.N., 2016. An innovative method of improving subgrade strength of soft soil using human hair fibers as reinforcement. International Journal of Scientific Research in Science, Engineering and Technology, 2(4), pp.551-554. Science, Engineering and Technology, Volume 2, Issue 4, 551-554 (2016).

Narayanan, K.S. and Sharmila, S.M.R., 2017. Stabilization of clay with human hair fiber. International Journal of Civil Engineering and Technology (IJCIET) Volume, 8.

1. Foamed Hair-reinforced Clay (FHRC) material is the subject of this invention, it is made of the combination of clay, water, foam, and natural hair with specified percentages.

2. In FHRC, introduced in claim 1, for the first time the combined usage of lightening admixture and reinforcing fibers is addressed.

3. The foam material used in FHRC can be natural- or artificial-based materials, and the hair used in it can be of human or animal origin.

4. FHRC can be used making panels in buildings, whether in-situ or by prefabrication.

5. The weight percentages and properties of the FHRC material ingredients are 73% clay passed through the sieve No. 25, 24% water, 1.5% foam, and 0.5% natural hair fiber pieces approximately 1.5 to 2 cm long.

6. The steps of making FHRC material:
A- Mixing water and foam liquid and stirring the mixture till reaching the maximum volume of the foam
B- Adding clay and hair strands pieces, and stirring the mixture again till having a uniform composition.

7. The specific weight of dried FHRC it is about 1370 kgf/m³ which is much lighter than ordinary clay with a dry specific weight of about 1850 kgf/m³.

8. Dry FHRC is stronger than ordinary clay in shear, bending and compressive strengths respectively 4, 6 and 1.5 times on average.

9. A piece of dry FHRC doesn’t break apart, even after cracking due to intensive forces, whereas a piece of ordinary clay disintegrates immediately after cracking.

10. Dry FHRC has more insulation capability against heat, sound and moisture than ordinary clay.

11. FHRC because of the higher resistances and better insulation, mentioned in claims 8 and 9, can be used in all types of conventional buildings as the main material for the construction of exterior and interior walls, false ceiling tiles, flooring and even load bearing walls in traditional masonry buildings.

12. Thanks to the lower density of FHRC, mentioned in claim 7 and its higher resistances, mentioned in claim 8, using FHRC in buildings can significantly improve their seismic behavior.
